(19) United States
(12) Patent Application Publication
(10) Pub. No.: US 2014/0076996 A1
(43) Pub. Date: Mar. 20, 2014

(54) SPRAY GUN AND PORTABLE MIST-GENERATING APPARATUS

(71) Applicant: TYCO FIRE & SECURITY GMBH, NEUHAUSEN AM RHEINFALL (CH)

(72) Inventors: CARL HAYTON, CAMBRIDGE (GB); JAMES OLIVER FRENCH, HUNTINGDON (GB); DAVID JAMES DOSWELL, SOMERSHAM (GB)

(73) Assignee: TYCO FIRE & SECURITY GMBH, NEUHAUSEN AM RHEINFALL (CH)

(21) Appl. No.: 14/086,680

(22) Filed: Nov. 21, 2013

Related U.S. Application Data
(63) Continuation of application No. 13/876,398.

(30) Foreign Application Priority Data
Oct. 8, 2010 (GB) 1016967.0

(51) Int. Cl. A62C 25/00

(52) U.S. Cl. CPC A62C 25/005
USPC 239/152; 239/526; 239/436; 239/337; 239/289; 239/172

(57) ABSTRACT

A spray gun is provided, which comprises a twin fluid atomizing nozzle which atomises a process fluid by interaction with a driving fluid. The nozzle including a driving fluid passage having a driving fluid inlet, a driving fluid outlet, and a throat portion intermediate the driving fluid inlet and driving fluid outlet. The throat portion has a cross sectional area which is less than that of both the driving fluid inlet and the driving fluid outlet. The nozzle also includes a process fluid outlet located at, or downstream of, the driving fluid throat. The spray gun further comprises a flow adjustment device connectable to supplies of the driving and process fluids. The flow adjustment device is adapted to selectively vary the ratio of the process fluid to driving fluid supplied to the nozzle. A mist-generating apparatus incorporates this spray gun is also provided.

The present invention relates to the field of mist generation. More specifically, the present invention provides a spray gun and a portable mist-generating apparatus. The spray gun and apparatus are particularly suitable for rapid deployment and operation in decontamination, disinfection and fire suppression applications within buildings and other urban environments.

Portable mist-generating apparatus are known. These apparatus typically take the form of a backpack which is carried on the back of an operator, and a spray gun, or lance, which is held in the hands of the operator and is fluidly connected to the backpack for spraying the contents thereof. These known apparatus rely on compressed gas to force the liquid stored in the backpack under pressure into the nozzle of the spray gun, whereupon the small diameter of the nozzle atomises the liquid as it exits the gun. The compressed gas can be stored in a separate container within the backpack, or else can be held under pressure within the vessel containing the liquid.

As these apparatus rely on mechanical atomisation through the nozzle, the resultant mist is made up of relatively large droplets. Consequently the droplets fall to ground relatively quickly, thereby limiting the effectiveness of the apparatus unless the apparatus is immediately adjacent the zone in which the fire, infection or contamination is located. This of course places the operator handling the apparatus at greater risk. Furthermore, the larger the droplet size the less likely it is that the droplets will resist gravitational forces when landing upon surfaces which are not horizontal. In disinfection and decontamination applications in particular, being unable to cover non-horizontal and/or non-visible surfaces (e.g. vertical surfaces, the underside of horizontal surfaces) with droplets can limit the effectiveness of the disinfection or decontamination operation.

A solution to the aforementioned problem has been to employ twin-fluid atomisers in order to achieve smaller droplet sizes. However, existing twin-fluid atomisers have fixed flow rates for the two fluids, meaning that the ratio between the two fluids at the nozzle cannot be adjusted. This means that any apparatus employing such a device may be suitable for one application (e.g. high flow for fire suppression) but not particularly suitable for another application (e.g. low flow for cooling or decontamination purposes), where a spray having different characteristics is needed.

It is an aim of the present invention to obviate or mitigate the aforementioned disadvantages.

According to a first aspect of the present invention, there is provided a spray gun comprising:
a first atomising nozzle including a driving fluid passage having a driving fluid inlet, a driving fluid outlet, and a throat portion intermediate the driving fluid inlet and driving fluid outlet, the throat portion having a cross sectional area which is less than that of both the driving fluid inlet and the driving fluid outlet, and the first nozzle further including a process fluid outlet located at, or downstream of, the driving fluid throat; and
a flow adjustment device connectable to supplies of driving and process fluid, and adapted to selectively vary the ratio of process fluid to driving fluid supplied to the first nozzle.

The flow adjustment device may include a set of driving fluid orifices upstream of the driving fluid passage, and a set of process fluid orifices upstream of the process fluid outlet, wherein each orifice in each set is a different diameter and may be selectively brought into fluid communication with the first nozzle to vary the respective driving and process fluid flow rates thereto.

The spray gun may further comprise a spray head housing the flow adjustment device, and wherein the flow adjuster is rotatable relative to the spray head to select the desired driving and process fluid orifices.

Each driving and process fluid orifice may be surrounded by a sealing member which engages an inner surface of the spray head, thereby hydraulically isolating each orifice from the other orifices in their respective sets.

The spray gun may further comprise a grip portion having a remote end to which a trigger member is pivotably connected, and one or more control valves housed at the remote end of the grip portion, wherein the control valves are selectively actuated by the trigger for controlling flow of driving and process fluid into the gun.

The spray gun may further comprise driving and process fluid supply hoses connecting the one or more control valves to the flow adjuster, wherein the hoses span the grip portion to shield an operator's hand when holding the grip portion.

The first nozzle may include at least one driving fluid bypass channel having a bypass inlet connected to the driving fluid inlet upstream of the throat, and a bypass outlet in communication with the process fluid supply upstream of the process fluid outlet.

The spray gun may further comprise a second compressed air foam nozzle, and the flow adjuster can selectively divert the process and driving fluids away from the first nozzle to the second nozzle. The second nozzle may include an elongate expansion passage downstream thereof.

According to a second aspect of the invention, there is provided a mist-generating apparatus, comprising:
a portable frame having a driving fluid tank and a process fluid tank attached thereto; and
a spray gun according to the first aspect of the invention, wherein the flow adjuster is in fluid communication with the driving fluid and process fluid tanks.

The apparatus may further comprise a breathable air tank and breathing apparatus.

The apparatus may further comprise:
a driving fluid supply line connecting the driving fluid tank and the flow adjuster;
a regulator located on the driving fluid supply line and adapted to reduce the pressure of the driving fluid upstream of the flow adjuster; and
a manifold located on the driving fluid supply line downstream of the regulator, the manifold adapted to selectively divert driving fluid into the process fluid tank to pressurise the process fluid therein.

The apparatus may further comprise a flow restrictor intermediate the regulator and the flow adjustor, the restrictor comprising an elongate body having a bore whose diameter is substantially constant and less than that of the driving fluid supply line.

The frame may form part of a backpack to be carried by an operator. Alternatively, the frame may form part of a trailer which can be towed by a vehicle.

Preferred embodiments of the invention will now be described, by way of example only, with reference to the accompanying drawings. The drawings show the following:

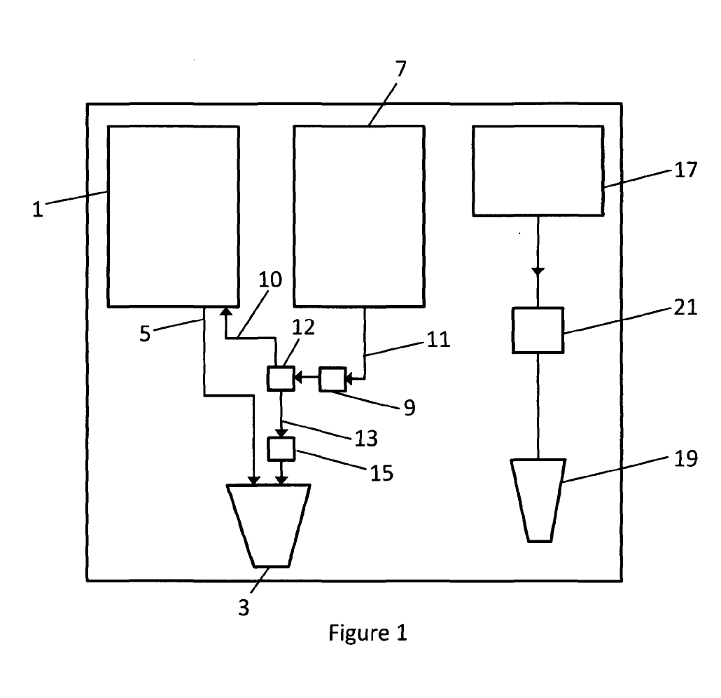

FIG. 1 is a schematic diagram of a portable mist-generating apparatus;

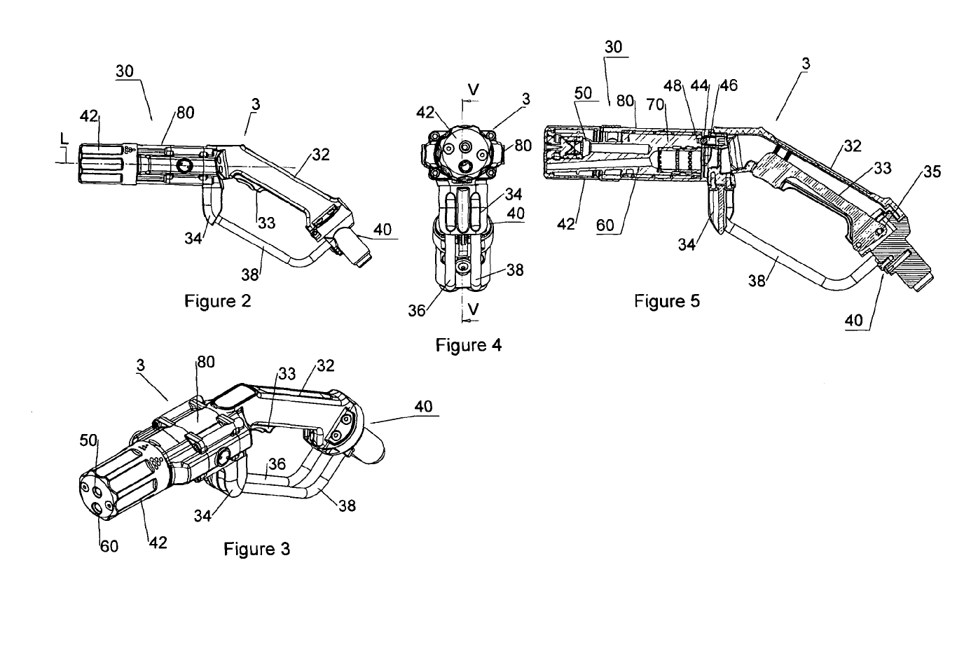

FIGS. 2-5 show side, perspective, front and longitudinal section views, respectively, of a spray gun suitable for use in the mist-generating apparatus;

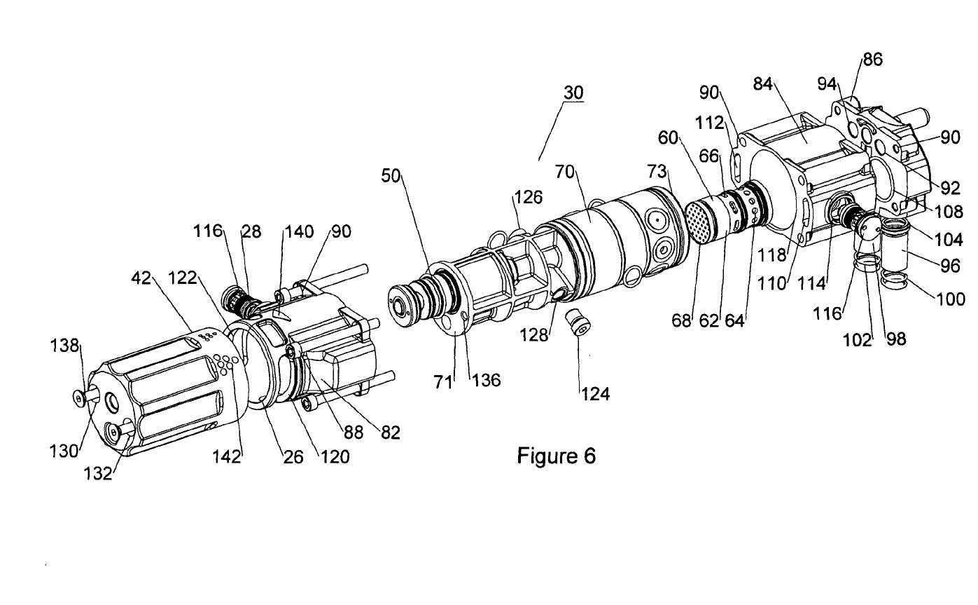

FIG. 6 is an exploded view of a spray head of the spray gun shown in FIGS. 2-5;

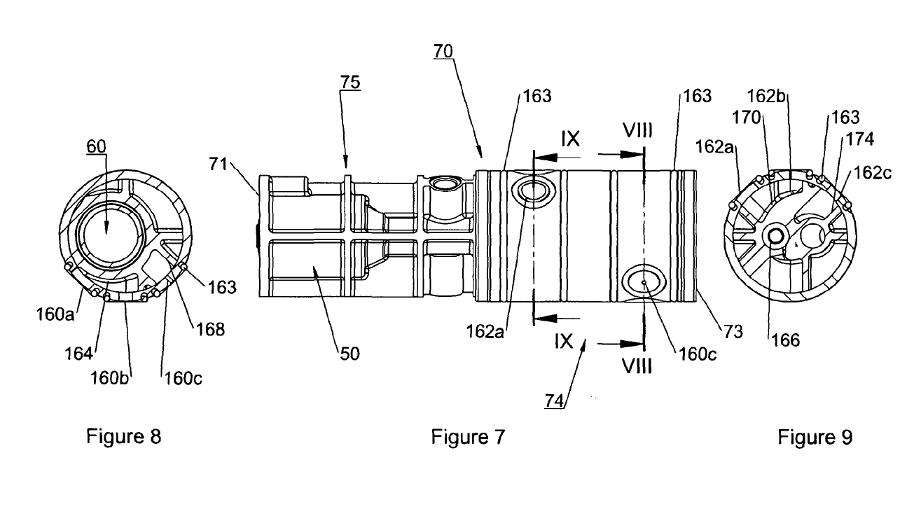

FIG. 7 is a side view of a fluid core of the spray head of FIG. 6;

FIGS. 8 and 9 are cross section views along the lines VIII-VIII and IX-IX shown in FIG. 7;

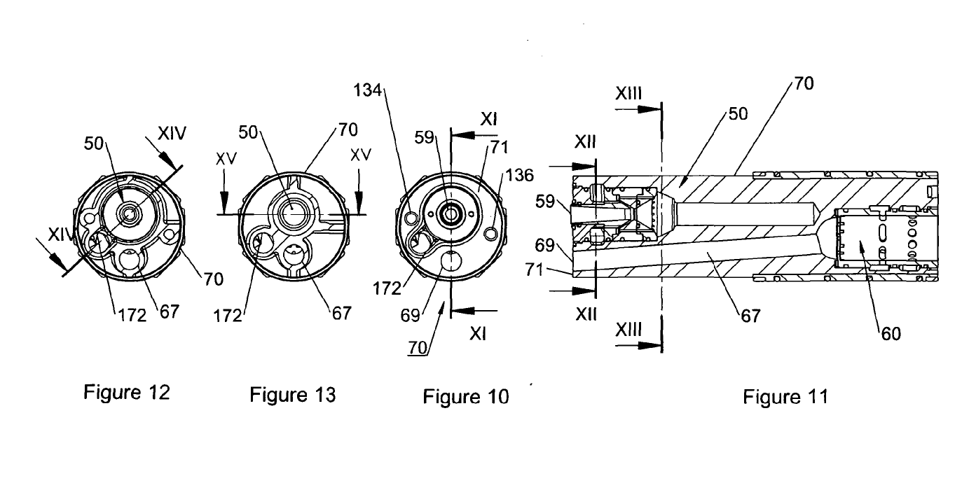

FIG. 10 is an end view of the fluid core of FIG. 7;

FIG. 11 is a longitudinal section view along the line XI-XI shown in FIG. 10;

FIGS. 12 and 13 are cross section views along the lines XII-XII and XIII-XIII shown in FIG. 11;

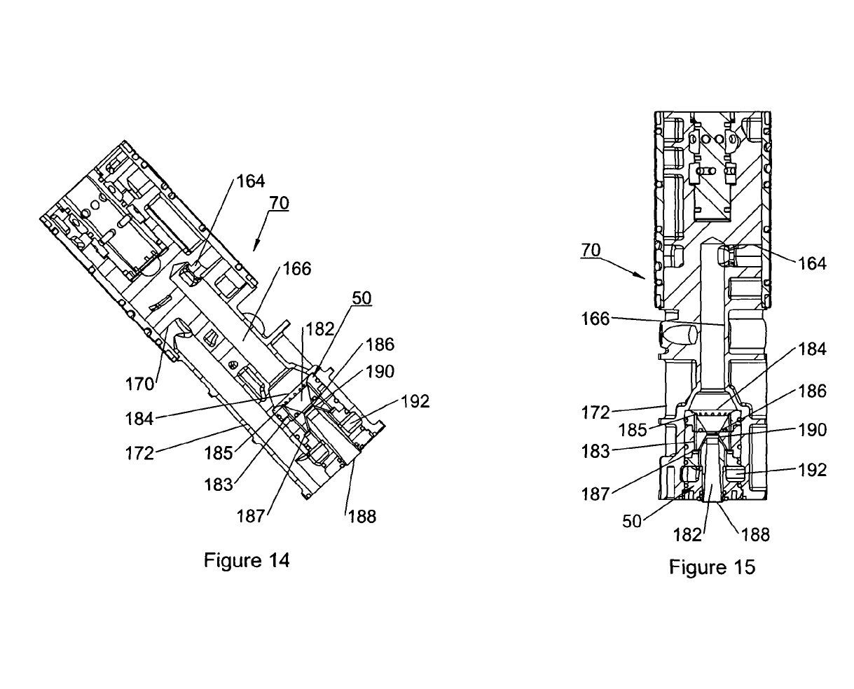

FIGS. 14 and 15 are section views along the lines XIV-XIV and XV-XV shown in FIGS. 12 and 13, respectively;

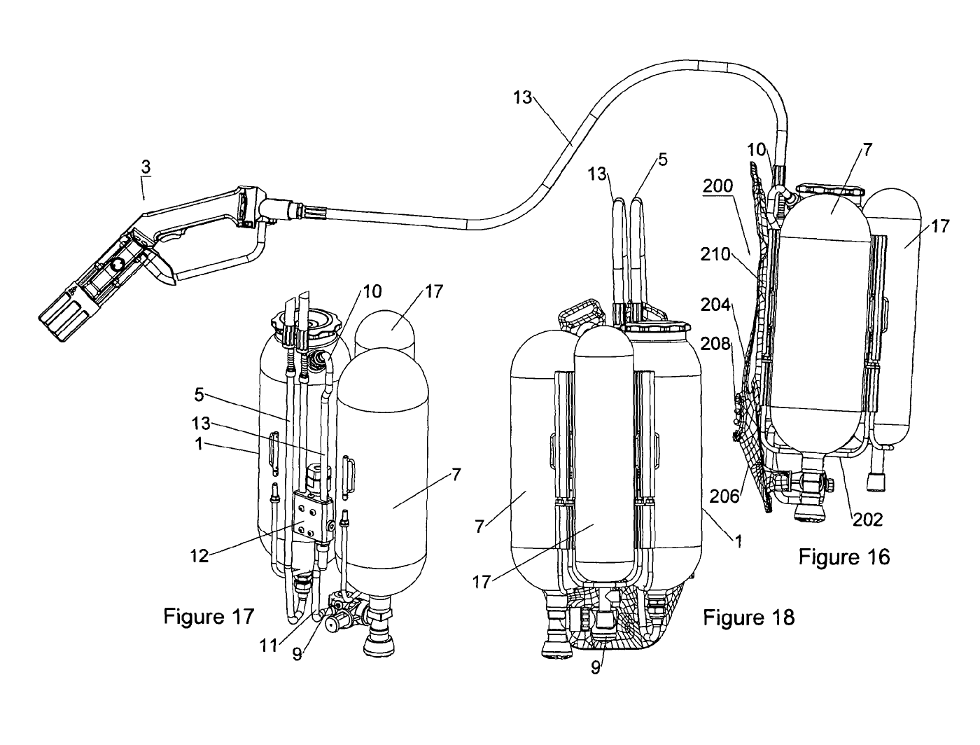

FIG. 16 is a side view of a portable mist-generating apparatus;

FIGS. 17 and 18 are rear and perspective views, respectively, of a backpack element of the apparatus shown in FIG. 16; and

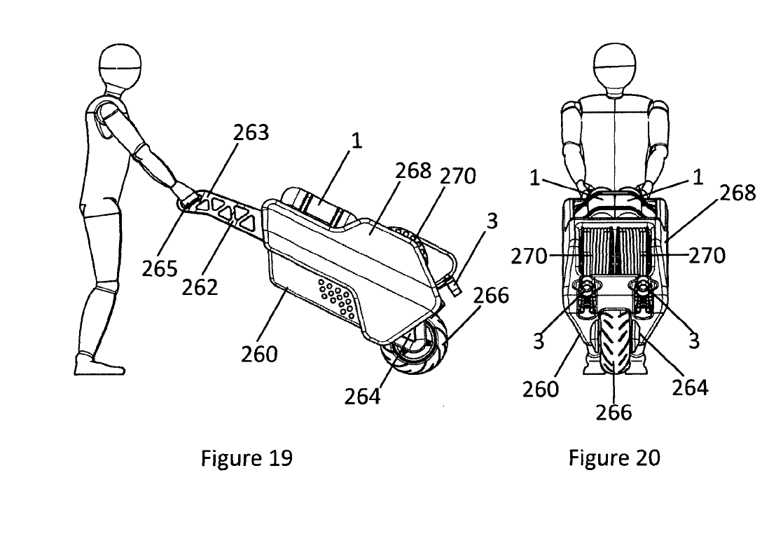

FIGS. 19 and 20 show side and front views, respectively, of an alternative embodiment of the mist-generating apparatus intended to be towed behind a vehicle.

FIG. 1 schematically shows the preferred components which make up a portable mist-generating apparatus according to the present invention. The apparatus comprises a process fluid tank 1 containing a volume of process fluid to be sprayed by the apparatus. The process fluid tank is in fluid communication with a spray gun, or lance, 3 via a first supply line 5. The apparatus further comprises a driving fluid tank 7 containing a volume of driving fluid, which drives the process fluid out of the apparatus as a mist. The driving fluid tank 7 may be in fluid communication with a regulator 9 via a second supply line 11. The regulator 9 reduces the pressure of the driving fluid for downstream applications. A manifold 12 may also be located in the second supply line 11 downstream of the regulator 9. The manifold 12 is in fluid communication with the process fluid tank 1 and can divert driving fluid from the second supply line 11 into the process fluid tank 1 via a divert line 10 in order to increase and/or maintain pressure therein. The manifold 12 is also in fluid communication with the spray gun 3 via a third supply line 13. The third supply line 13 may be provided with a further regulator, flow control valve or restrictor 15 in order to further reduce the pressure of the driving fluid prior to it reaching the spray gun 3. Most preferably the restrictor 15 comprises an elongate body with a bore whose diameter is substantially constant and less than that of the third supply line 13.

Optionally the apparatus may also include a separate breathable air supply for use by an operator during the operation of the apparatus. The air supply comprises a breathable air tank 17 which is in fluid communication with a conventional breathing apparatus 19. An air regulator 21 may be located between the air tank 17 and breathing apparatus 19 so as to regulate air flow to the breathing apparatus 19.

The tanks 1,7,17 may have shut-off valves (not shown) which allow fluid flow from the tanks into the remainder of the apparatus when the valves are opened.

An example of a spray gun 3 according to the present invention, and suitable for use with the mist-generating apparatus of FIG. 1, is shown in FIGS. 2-5. The gun 3 comprises a spray head 30 and a handle or grip portion 32 projecting rearwardly from the spray head 30. A hand guard may be provided so as to protect an operator's hand when gripping the handle 32. In the illustrated embodiment, the hand guard comprises a pair of reinforced fluid supply hoses 36,38 spanning the underside of the handle 32. The guard may also comprise a shield member 34 attached to the underside of the spray head 30 adjacent a proximal end of the handle 32. First ends of the fluid supply hoses 36,38 connect into the spray head 30, whilst second ends of the hoses 36,38 connect into one or more control valves 40 which are attached to a distal end of the handle 32. The handle 32 incorporates a pivotable trigger 33 which, when squeezed, pivots about a pivot point 35 adjacent the distal end of the handle 32 and actuates the control valve(s) 40 so that driving and process fluids may enter the spray head 30.

The spray head 30 comprises a first twin fluid atomising nozzle 50 and may further comprise a second, compressed air foam (CAF) nozzle 60. The nozzles 50,60 are located within a flow adjustment device in the form of a fluid core 70, which is housed within the spray head 30 and can be rotated about a longitudinal axis L relative to the spray head 30 so as to switch the spray gun between different modes of operation, as will be explained in more detail below. The fluid core 70 is at least partially located within a selector sleeve 42 and non-rotatably coupled thereto, such that rotation of the selector sleeve 42 rotates the fluid core 70 relative to the spray head 30. A locator pin or ball 44 is biased by a biasing means 46 from the rear of the spray head 30 into one of a number of locator recesses 48 on the adjacent end of the fluid core 70. As the fluid core 70 is rotated relative to the spray head 30, the locator ball 44 will be pushed from its present recess against the force of the biasing means 46 and then enter into the next recess on the core 70. In this way the core 70 can be selectively secured in a number of positions which correspond to the different operating modes of the gun 3.

The spray head 30 is shown in exploded form in FIG. 6. The spray head 30 comprises a housing 80 within which the fluid core 70 is rotatably mounted. The housing 80 is made up of three elements: a front fluid housing 82, a rear fluid housing 84, and a filter housing 86. Each of the housing elements is formed such that they can be assembled into a single housing 80 and secured together by a number of fixing bolts 88 extending through a corresponding number of assembly apertures 90 formed within the elements.

The filter housing 86 includes driving and process fluid supply passages 92,94 connectable to supplies of driving and process fluids, as well as a pair of filters 96,98 which are located in filter apertures (not shown) and biased into the supply passages 92,94 by respective filter springs 100,102. A sealing collar 104 atop each filter 96,98 ensures that the fluids do not leak from the passages 92,94 with the filters 96,98 in place.

On the rear face of the rear fluid housing 84 are driving and process fluid recesses (not shown) which, when the housing elements are all assembled together, form driving and process fluid chambers which are in fluid communication with the respective driving and process fluid supply passages 92,94. Each recess has an O-ring seal 108 which is compressed between the filter housing 86 and rear fluid housing 84 when those elements are secured together so that no fluid may leak from the chambers where the rear fluid and filter housings 84,86 abut one another. Located on opposite sides of the rear fluid housing 84 are driving and process fluid galleries 110,112 which are in fluid communication with their respective driving and process fluid chambers. Access ports 114 are provided either side of the rear fluid housing 84 so that the internal portions of the rear fluid housing 84 can be machined more easily, and so that the galleries 110,112 may be accessed for maintenance purposes. In service, each access port 114 is sealed by a removable sealing plug 116.

As can be seen the fluid core 70 is located within a central bore 118 within the front and rear fluid housings 84,86. The fluid core 70 will be described in more detail below, but first twin fluid atomising nozzle 50 and second compressed air foam (CAF) nozzle 60 can be seen in FIG. 6. The first and second nozzles 50,60 are housed in nozzle chambers at respective first and second ends 71,73 of the fluid core 70.

The CAF nozzle 60 has a substantially cylindrical body 62, with two sets of circumferentially spaced driving fluid and process fluid apertures 64,66 through which the respective fluids enter the nozzle 60. Within the body 62 downstream of the apertures 64,66 are a plurality of perforated discs 68 through which the fluids must pass before exiting the nozzle 60.

The front fluid housing 82 includes a pair of circumferential guide slots 120,122. During assembly, the front fluid housing 82 is secured to the rear fluid housing 84 over the fluid core 70, and then a pair of guide pins 124,126 are inserted into the guide slots 120,122 and secured in corresponding threaded guide apertures 128 on the exterior of the fluid core 70. In this way, relative movement between the housing 80 and fluid core 70 is not possible in the axial direction, but is possible in the rotational direction. The guide slots 120,122 are of a predetermined length so as to limit relative rotational movement to only that necessary to cover the various adjustment positions of the spray head 30.

The final step in assembling the spray head 30 is to place the adjuster sleeve 42 over the end of the front fluid housing 82 so that locating apertures 130,132 in the end of the sleeve 42 align with corresponding apertures 134,136 in the first end 71 of the fluid core 70. Mechanical fixtures 138 locate in the apertures to non-rotatably fix the sleeve 42 to the fluid core 70. Thus, rotation of the sleeve 42 will rotate the fluid core 70 relative to the housing 80. A reference indicator 140 is provided on the exterior of the front fluid housing 82, and mode indicators 142 are provided on the exterior of the sleeve 42. These indicators 140,142 co-operate to indicate the relative rotational position of the fluid core 70 within the housing 80, and hence the current operating mode of the spray head 30.

The fluid core 70 is shown in more detail in FIGS. 7-15. Referring initially to FIGS. 7-9, the core 70 comprises an upstream section 74 and a downstream section 75. The upstream section 74 contains two sets of driving fluid and process fluid orifices 160,162, which are axially spaced from one another on the exterior of the upstream section 74. Each of the orifices 160,162 has a different diameter, such that the fluid flow rate through each orifice 160,162 will differ from the others. In the illustrated embodiment, there are three driving fluid orifices 160a-c and three process fluid orifices 162a-c. Referring to FIGS. 8 and 9, each orifice in the respective sets 160,162 is circumferentially spaced from the other orifices in its set with a predetermined rotational angle between each orifice in each set. In the illustrated example each orifice is at 22.5° relative to the adjacent orifice in its set. The two sets of orifices 160,162 are also diametrically opposed on the core 70, so that corresponding orifices (e.g. 160b,162b) in each set will be in fluid communication with their respective galleries 110,112 in the rear fluid housing 84 at the same time.

The two sets of orifices 160,162 can be seen in the section views of FIGS. 8 and 9. FIG. 8 shows the three driving fluid orifices 160a-c. The first driving fluid orifice 160a has the largest diameter, whilst the diameter of the second driving fluid orifice 160b is less than that of the first orifice 160a. The diameter of the third driving fluid orifice 160c is smaller than both the first and second orifices 160a,160b. As will be explained in more detail below, the first and second driving fluid orifices 160a 160b are for use in high flow (e.g. fire suppression) and low flow (e.g. decontamination) modes of the spray gun, whilst the third driving fluid orifice 160c is for use in a foaming mode. The first and second driving fluid orifices 160a,160b are in fluid communication with a driving fluid gallery 164 which is in turn in fluid communication with a first driving fluid passage 166 (not shown in FIG. 8), which delivers driving fluid into the twin fluid atomising nozzle 50 within the core 70. The third driving fluid orifice 160c is in fluid communication with a second driving fluid passage 168 which delivers driving fluid into the CAF nozzle 60 within the core 70. Each of the driving fluid orifices 160a-c is surrounded by an O-ring seal 163 which seals against the wall of the central bore 118 within the rear fluid housing 84. These seals 163 allow the orifices, and hence the various modes of operation of the spray gun, to be hydraulically isolated from one another.

FIG. 9 shows the process fluid orifices 162a-c and as with the driving fluid orifices 160 the first process fluid orifice 162a has the largest diameter whilst the diameter of the second process fluid orifice 162b is less than that of the first orifice 162a. However, the diameter of the third process fluid orifice 162c is smaller than that of the first orifice 162a, but greater than that of the second orifice 162b. As with the driving fluid orifices 160, the first and second process fluid orifices 162a,162b are for use in high flow (e.g. fire suppression) and low flow (e.g. decontamination) modes of the spray gun, whilst the third process fluid orifice 162c is for use in the foaming mode. The first and second process fluid orifices 162a,162b are in fluid communication with a process fluid gallery 170 which is in turn in fluid communication with a first process fluid passage 172 (not shown in FIG. 9), which delivers process fluid into the twin fluid atomising nozzle 50 within the core 70. The third process fluid orifice 162c is in fluid communication with a second process fluid passage 174 which delivers process fluid into the CAF nozzle 60 within the core 70. As with the driving fluid orifices 160a-c, each of the process fluid orifices 162a-c is surrounded by an O-ring seal 163 which seals against the wall of the central bore 118 within the rear fluid housing 84 to hydraulically isolate each mode of operation of the spray gun.

FIG. 10 is a view of the first end 71 of the fluid core 70. It shows a first nozzle outlet 59 of the first, twin fluid nozzle 50 and a second nozzle outlet 69 of the second, CAF nozzle 60. Also visible are the apertures 134,136 by which the sleeve 42 is non-rotatably attached to the core 70. The first process fluid passage 172 is also visible in FIG. 10 as it opens on the first end 71 of the core 70. However, referring back to FIG. 6 is should be understood that when the gun is assembled the first end 71 of the core 70 abuts a rear face (not shown) of the front fluid housing 82, such that the first process fluid passage 172 is sealed off by the front fluid housing 82 when all of the components are assembled together.

FIG. 11 shows a longitudinal section through the fluid core 70. Both the first and second nozzles 50,60 are shown, although it should be noted that the internal components of the second nozzle 60 have been omitted for clarity. The first nozzle 50 will be described in detail below, but it can be seen in FIG. 11 that the outlet 69 of the second nozzle 60 is at the end of an elongate expansion passage 67 extending along much of the length of the core 70 from the second nozzle 60. FIGS. 12 and 13 show the relative positions of the first nozzle 50, second nozzle expansion passage 67, and the first process fluid passage 172 at two points adjacent the first end 71 of the core 70.

The first nozzle 50 can be seen in more detail in the longitudinal section views of FIGS. 14 and 15. As already described above, the first process fluid passage 172 conveys process fluid from the process fluid gallery 170 to the nozzle 50, and the first driving fluid passage 166 conveys driving fluid from the driving fluid gallery 164 to the nozzle 50. The nozzle 50 itself has a central passage 182 having an inlet 184 in fluid communication with the first driving fluid passage 166. The central passage 182 also has an outlet 188 and a throat portion 186 intermediate the inlet 184 and the outlet 188. The throat portion 186 has a cross sectional area which is less than that of both the inlet 184 and the outlet 188.

A process fluid outlet 190 circumscribes at least part of the central passage 182 and opens into the central passage 182 at, or downstream of, the throat portion 186. The process fluid outlet 190 is connected to the first process fluid passage 172 via an annular chamber 192 which surrounds a portion of the central passage 182.

The process fluid outlet 190 may be adapted, as is shown in the illustrated embodiment, so that the process fluid is introduced into the central passage 182 in the opposing direction to the direction of flow of driving fluid through the central passage 182. In addition, the first nozzle 50 may include one or more driving fluid bypass channels 183, with each bypass channel 183 having an inlet 185 connected to the central passage inlet 184 upstream of the central passage throat 186, and an outlet 187 in the process fluid passage intermediate the annular chamber 192 and the process fluid outlet 190. In this way a small portion of the driving fluid can be introduced into the process fluid prior to the process fluid entering the nozzle 50, thus effecting a partial atomisation of the process fluid before the full atomisation takes place within the nozzle 50.

FIGS. 16-18 illustrate an embodiment of the invention which is to be carried by an operator. The supply components of the system are mounted in a backpack 200 which can be carried on the back of the operator. The backpack 200 has been omitted from FIG. 17 for illustrative purposes, but as shown in FIG. 16 it includes a frame 202, a pair of shoulder straps 204 and a waist strap 206. One end of each shoulder strap 204 is attached to an upper portion of the frame 202 whilst the other end of each shoulder strap 204 is attached to respective ends of the waist strap 206. A two-piece snap-fit clasp 208 is provided, with one piece attached to either end of the waist strap 206, for securing the backpack 200 to the operator. The frame 202 includes one or more back pads 210 which provide the operator with a degree of cushioning when wearing the backpack 200.

Referring to FIGS. 1 and 16-18, the process fluid, driving fluid and (where present) breathable air tanks 1,7,17 are removably attached to, and supported by, the backpack frame 202. The tanks 1,7,17 may all be attached to the frame 202 in the upright position or, as illustrated they may all be inverted with their respective supply lines running up inside the frame 200. In this preferred embodiment, each of the process and driving fluid tanks 1,7 has a 6 litre capacity. The spray gun 3 may be removably attached to one of the shoulder straps 204, whilst the breathing apparatus 19 (shown in FIG. 1) may be removably attached to the other of the shoulder straps 204 so that the operator may have both hands free when not using the apparatus.

FIGS. 16-18 also show the various supply lines and associated components shown schematically in FIG. 1. The process fluid tank 1 supplies process fluid to the spray gun 3 via the first supply line 5. The driving fluid tank 7 supplies driving fluid to the spray gun via the second supply line 11, regulator 9, and third supply line 13. As previously described, the regulator 9 may be in fluid communication with the process fluid tank 1 and selectively divert driving fluid from the second supply line 11 into the process fluid tank 1 via the divert line 10 in order to increase and/or maintain pressure therein.

FIGS. 19 and 20 show an alternative embodiment of the invention which is to be towed behind a vehicle, which is preferably a motorcycle in order to allow the apparatus to reach a desired location quickly and without being hindered by heavy traffic in urban locations. The apparatus may also be manoeuvred by hand in the manner of a wheelbarrow as shown in the figures. The apparatus comprises a frame 260, which has a tow bar 262 at one end thereof and a wheel mounting portion 264 at the opposite end of the frame from the tow bar 262. The free end 263 of the tow bar 262 is provided with means for attaching the tow bar 262 to a vehicle, and also at least one hand grip 265 which allows an operator to manoeuvre the apparatus by hand. At least one wheel 266 is rotatably supported on the wheel mounting portion 264. Mounted on the frame 260 is a body 268 upon which the supply components of the system are mounted.

Referring to FIGS. 1, 19 and 20 the process fluid and driving fluid tanks 1,7 are removably attached to, and supported by, the body 268. In this particular embodiment there are two sets of tanks 1,7 but only the process fluid tank 1 of each set is visible in FIGS. 19 and 20. A pair of spray guns 3 are removably attached to the body 268 adjacent the wheel mounting portion 264 of the frame 260. Each spray gun 3 is connected to its respective set of process and driving fluid tanks 1,7 by supply lines coiled on revolving reels 270, which are rotatably supported by the body 268. With two sets of tanks 1,7 and a pair of spray guns 3 the apparatus allows two operators to be at work at the same time. However, the apparatus may only comprise one set of tanks 1,7 and a single spray gun 3, or a plurality of tanks 1,7 and respective spray guns 3 depending on requirements.

The manner in which the spray gun and apparatus operate will now be described. Initially, the process and driving fluid tanks 1,7 are filled with their respective fluids. The process fluid may be water, a liquid decontaminant or a liquid fire suppressant, for example, and may be pressurised within the tank 1. The driving fluid may be a gas such as compressed air, carbon dioxide or nitrogen, for example, and is held in its respective tank 7 at a relatively high pressure (e.g. 300 bar gauge). When present, the regulator 9 and manifold 12 allow the driving fluid to perform two functions. Firstly, the regulator 9 reduces the pressure of the driving fluid to a much lower pressure (e.g. 11 bar gauge), and the manifold 12 can then direct a portion of the lower pressure driving fluid into the process fluid tank 1 as required to pressurise the process fluid and force it from its tank 1 along supply line 5 to the spray gun 3. Secondly, as will be explained in more detail below, with or without the manifold 12 driving fluid not directed into the process fluid tank 1 is fed directly into the spray gun 3 via supply line 13, where it atomises the process fluid in the spray gun 3.

The restrictor 15 is preferably provided in supply line 13 to drop the driving fluid pressure to a still lower pressure (e.g. 8.5 bar gauge) before the driving fluid enters the spray gun.

With the tanks 1,7 connected to the spray gun 3 via their respective supply lines 5,11,13 and their shut-off valves opened, process and driving fluid will flow towards the spray gun 3. Referring to FIGS. 2-5 in particular, the trigger 33 and control valve(s) 40 are initially in their closed positions such that no fluid can flow into the gun 3. In this way, the system is primed and ready to use but will not begin to spray a mist until the trigger 33 is squeezed and pivots about pivot pin 35 in order to actuate the control valve(s) 40. The process and driving fluids can then flow through the hoses 36,38 into their respective driving and process fluid supply passages 92,94 at the spray head 30.

As the fluids flow into the fluid supply passages 92,94 they will also flow through the optional filters 96,98 and from there enter their respective galleries 110,112. As explained above, the fluid core 70 has three driving fluid orifices 160a-c and three process fluid orifices 162a-c. The rotational position of the fluid core 70 determines which of these orifices 160,162 are in fluid communication with the galleries 110,112 and hence which mode the spray gun is in.

Typically, the spray head 44 will be in a first, high flow setting initially, wherein the ratio of process fluid to driving fluid at the atomising nozzle 80 is substantially 8:1. That is, a flowrate of 8 kg/min of process fluid for every 1 kg/min of driving fluid. In this non-limiting example, the pressures of the fluids as they enter the nozzle in the high flow setting will be approximately 11 bar gauge for the process fluid and 8.5 bar gauge for the driving fluid. Adjusting the spray head 44 to a second, low flow setting decreases the aforementioned ratio of process fluid to driving fluid to substantially 2:1. That is, a flowrate of 2 kg/min of process fluid for every 1 kg/min of driving fluid. In the low flow mode with 2:1 flow ratio, the smaller diameter orifices 160b,162b create the required flow restrictions within the fluid core 70 to reduce the pressure of both fluids to 4.2 bar gauge. In some applications the low flow mode may reduce the aforementioned flow ratio to 1:1, that is 1 kg/min of process fluid for every 1 kg/min of driving fluid. The spray head 44 may include one or more intermediate settings between low and high flow, which produce corresponding intermediate flow ratios.

When the fluid core 70 is in either the low or high flow setting, driving and process fluids arrive at the first nozzle 50 via their respective supply passages 166,172. As the throat portion 186 of the central passage 182 has a smaller cross sectional area than both the inlet 184 and outlet 188 of the passage 182, pressurised driving fluid entering the throat 186 undergoes a significant acceleration. At the same time, a thin annulus of process fluid enters the passage 182 at, or downstream of, the throat 186 via the process fluid outlet 190. As the accelerating driving fluid hits the annulus of process fluid it applies a shear force to the process fluid. The driving fluid may also undergo an expansion downstream of the throat 186, thereby generating a turbulent zone in the passage 182 which leads to further atomisation of the process fluid. The differences in velocity, temperature and pressure between the driving and process fluids in the nozzle 50 may also lead to a momentum transfer from the high velocity driving fluid to the lower velocity process fluid. This combination of shear, turbulence and momentum transfer atomises the process fluid and creates a dispersed phase of process fluid droplets in a continuous vapour phase of driving fluid downstream of the nozzle throat 186. This flow then exits the nozzle outlet 188 as a mist plume of process fluid droplets.

In tests, 90% of droplets, by volume, contained in a mist generated using the first nozzle in a low flow setting (1:1 flow ratio between the process fluid and driving fluid) were measured as being smaller than 100 μm (i.e. Dv90=100 μm). On the same setting 90% of droplets, by frequency, in the mist were measured as being smaller than 5 μm (i.e. Dn90=5 μm).

When the low flow ratio was increased to 2:1 process fluid to driving fluid, Dv90 increased to 141.3 μm and Dn90 increased to 8.5 μm. In the first, high flow setting (8:1 flow ratio between the process fluid and the driving fluid) 90% of droplets, by volume, in the generated mist were measured as being smaller than 280 μm (i.e. Dv90 =280 μm), whilst 90% of droplets, by frequency were measured as being smaller than 148 μm (i.e. Dn90=148 μm). In the tests, the results were obtained using a Malvern SprayTec device sampling at 1 Hz over a period of 30 seconds of continuous spraying at a point 4.7 m from the nozzle outlet. The process fluid was water and the driving fluid was compressed air. The ratio of water pressure to gas pressure at the nozzle was approximately 1:1 in the first setting and 1.4:1 in the second setting.

When the spray gun is to be used in CAF mode, a process fluid tank containing an aqueous film-forming foam (AFFF) is attached to the frame of the backpack or trailer and connected to the gun 3 via the supply line 5. The fluid core 70 is then rotated into the CAF position wherein orifices 160c,162c connect their respective galleries 110,112 with the driving and process fluid apertures 64,66 of the CAF nozzle 60. Once the trigger 33 is operated and the control valve(s) 40 open the fluids flow into the CAF nozzle 60, whereupon a CAF mixture consisting of bubbles of the driving fluid within the AFFF fluid is created. The resultant foaming mixture then expands as it travels along the expansion passage 67 before being sprayed from the outlet 69.

Thanks to the first, twin fluid atomising nozzle, the spray gun and apparatus are able to generate a mist of very small droplets and project that mist over a substantial distance. Thanks to the combination of shear, turbulence and momentum transfer between the high velocity driving fluid and the process fluid the droplets generated by the atomising nozzle are smaller than those which can be generated by conventional portable mist/spray apparatus and consequently are able to adhere to substantially vertical surfaces as well as out of sight surfaces such as the undersides of tables and chairs, for example.

By providing a spray gun which can be adjusted to vary the ratio of process fluid to driving fluid entering the first nozzle, and/or switch from a twin fluid atomising nozzle to a compressed air foam nozzle, the present invention allows an operator to deal with an incident in the most efficient way without the need to carry extra components to cover all eventualities. For example, the 1:1 or 2:1 ratio setting is preferable for decontamination and heat suppression operations, whereas the 8:1 ratio setting is preferably for directly addressing the seat of a fire, for example, whilst the CAF nozzle is for use where foam suppressants need to be deployed. The operator can adjust the settings simply by rotating the selector sleeve at the spray head.

The portability of the mist generating apparatus of the present invention, whether on the back of an operator or towed by a vehicle, makes it suitable for use by teams of fast-action first responders sent to tackle incidents involving fire, contamination, infection or a combination thereof.

By locating the trigger pivot mechanism and control valve arrangement at the rear of the hand grip, the present invention also provides an ergonomically improved spray gun. This provides a degree of opposite moment to the spray head of the gun, meaning that the gun is better balanced in an operator's hand.

The apparatus may further comprise a compressor adapted to pressurise the driving fluid stored within the driving fluid tank.

The tanks may be detached from the backpack or trailer frame in order to be refilled or replaced. Consequently, different tanks containing different process fluids can be attached dependent on the application for the system.

The spray gun may further comprise an infra red camera and display module to assist an operator in detecting the seat of a fire, for example. The display module may include an electronic control unit incorporating one or more of the following functions: a GPS system, compass, tank fluid level monitor and display, thermometer, and text-based communication system for use when conventional audio communication is not possible.

Whilst the presence of the CAF nozzle is preferred, the invention is not limited to a spray gun incorporating the CAF nozzle. Instead, the spray gun may only comprise the twin fluid atomising nozzle employing the high and low flow modes. The CAF nozzle may also be replaced by an alternative nozzle offering particular spray characteristics, with the alternative nozzle still being in parallel with the first nozzle.

The spray head of the gun is preferably rotatable in order to adjust the spray gun mode. However, an alternative embodiment of the gun incorporating only the twin fluid atomising nozzle may instead have a fixed spray head and fluid core, and a flow adjustment device in the form of an outer sleeve rotatably supported on the spray head. The sleeve has a cylindrical portion extending axially between the fluid housing and the fluid core. The extending portion of the sleeve has the sets of driving and process fluid orifices thereon, and rotation of the sleeve relative to the housing and fluid core will selectively bring one of the inlet apertures into communication with the galleries of the fluid housing and the internal passageways of the fluid core. This provides an alternative manner in which the mode of the spray gun may be selected and the flow ratios of the fluid adjusted.

The process fluid tank may comprise a primary reservoir and a secondary reservoir, the secondary reservoir being adapted to selectively introduce its contents into the primary reservoir. The tank may include an actuator in order to manually introduce the secondary reservoir contents into the primary reservoir. With a twin reservoir process fluid tank, the apparatus may be selectively used for two applications. For example, with water in the primary reservoir and a concentrated disinfection or decontamination agent in the secondary reservoir, the apparatus may be used for fire suppression (i.e. using water only) or decontamination depending on whether the operator chooses to introduce the agent from the secondary reservoir into the primary reservoir. In a modification to this embodiment, the process fluid tank may be adapted such that the agent in the secondary reservoir is mixed with the process fluid from the primary reservoir downstream of the primary reservoir rather than the agent being introduced directly into the primary reservoir. A further manifold or similar flow control device may be included in either of these embodiments so as to control the rate at which the contents of the secondary reservoir are introduced to the process fluid.

The secondary reservoir may be in a separate casing to the primary reservoir. There may be a plurality of secondary reservoirs containing a whole series of different types of additive such as, for example, decontamination materials, concentrated solutions or powders. These secondary reservoirs may be controlled by a regulating/mixing device so as to be mixed individually or in combination with the fluid from the primary reservoir so as to make different decontamination solutions for tackling different hazards. These different mixing scenarios could be chosen by the operator depending on the information they receive about the nature of the threat they are facing, so as to produce a tailored solution for a particular hazard, or a broad spectrum treatment where details of the hazard are less clear. The secondary reservoirs, if separate from the primary reservoir, may be individually pressurized (e.g. with gas inside) or also driven by a supply of driving fluid from the driving fluid tank 7 via an appropriate manifold arrangement. In some applications the secondary reservoirs may be connectable to the CAF fluid supply, either at point of mixing with the driving fluid or upstream thereof, so as to produce a foam with decontaminating chemicals incorporated in it.

The trailer may further comprise additional reels of piping or hose that are deployed behind the trailer as it enters the scene of the incident. A free end of the hose is left outside of the scene and contains connectors such that subsequent teams of operators (so-called “second responders”) can connect additional sources of the fluids to the additional hoses. In this way, the operators already in the hazardous environment around the scene can be supplied with additional fluids in order to continue operating without having to leave the scene to replenish their tanks.

The trailer body may incorporate a stretcher for driving casualties away from a scene.

The spray gun may include a puncture tool attached to the spray head for creating holes in doors and the like, thereby allowing the operator to spray into a room without entering the space.

It should be appreciated that the invention is not limited to the specific flow ratios referred to in description of the preferred embodiment. Whilst these ratios are preferred, the invention may be modified so that other flow ratios are obtained when the flowrate of the process fluid is adjusted at the spray head.

Neither is the invention limited to the specific atomising nozzle utilised in the preferred embodiment, as it is not essential that the process fluid outlet opens into the central nozzle passage. Instead, the process fluid outlet may be located at any point at, or downstream of, the central passage throat. This includes an atomising nozzle having a process fluid outlet which opens into the driving fluid flow downstream of the central passage outlet.

By providing O-ring seals around each of the driving and process fluid orifices on the fluid core, the spray gun of the present invention may switch between different modes of operation, but hydraulically isolates those different modes from one another. As an alternative or supplement to the O-ring seals the rear fluid housing may incorporate a pair of spring-loaded plungers, which selectively engage respective driving and process fluid orifices from each set and provide the fluid communication between the driving and process fluid galleries in the rear fluid housing and the passages within the fluid core.

These and other modifications and improvements may be incorporated without departing from the scope of the invention.

1. A spray gun comprising:
a first atomising nozzle including a driving fluid passage having a driving fluid inlet, a driving fluid outlet, and a throat portion intermediate the driving fluid inlet and driving fluid outlet, the throat portion having a cross sectional area which is less than that of both the driving fluid inlet and the driving fluid outlet, and the first nozzle further including a process fluid outlet located at, or downstream of, the driving fluid throat; and
a flow adjustment device connectable to supplies of driving and process fluid, and adapted to selectively vary the ratio of process fluid to driving fluid supplied to the first nozzle.

2. The spray gun of claim 1, wherein the flow adjustment device includes a set of driving fluid orifices upstream of the driving fluid passage, and a set of process fluid orifices upstream of the process fluid outlet, wherein each orifice in each set is a different diameter and may be selectively brought into fluid communication with the first nozzle to vary the respective driving and process fluid flow rates thereto.

3. The spray gun of claim 2, further comprising a spray head housing the flow adjustment device, and wherein the flow adjuster is rotatable relative to the spray head to select the desired driving and process fluid orifices.

4. The spray gun of claim 3, wherein each driving and process fluid orifice is surrounded by a sealing member which engages an inner surface of the spray head, thereby hydraulically isolating each orifice from the other orifices in their respective sets.

5. The spray gun of claim 1, further comprising a grip portion having a remote end to which a trigger member is pivotably connected, and one or more control valves housed at the remote end of the grip portion, wherein the control valves are selectively actuated by the trigger for controlling flow of driving and process fluid into the gun.

6. The spray gun of claim 5, further comprising driving and process fluid supply hoses connecting the one or more control valves to the flow adjuster, wherein the hoses span the grip portion to shield an operator's hand when holding the grip portion.

7. The spray gun of claim 1, wherein the first nozzle includes at least one driving fluid bypass channel having a bypass inlet connected to the driving fluid inlet upstream of the throat, and a bypass outlet in communication with the process fluid supply upstream of the process fluid outlet.

8. The spray gun of claim 1, further comprising a second compressed air foam nozzle, and the flow adjuster can selectively divert the process and driving fluids away from the first nozzle to the second nozzle.

9. The spray gun of claim 8, wherein the second nozzle includes an elongate expansion passage downstream thereof.

10. A mist-generating apparatus, comprising:
a portable frame having a driving fluid tank and a process fluid tank attached thereto; and
the spray gun of claim 1, wherein the flow adjuster is in fluid communication with the driving fluid and process fluid tanks.

11. The apparatus of claim 10, further comprising a breathable air tank and breathing apparatus.

12. The apparatus of claim 10, further comprising:
a driving fluid supply line connecting the driving fluid tank and the flow adjuster;
a regulator located on the driving fluid supply line and adapted to reduce the pressure of the driving fluid upstream of the flow adjuster; and a manifold located on the driving fluid supply line downstream of the regulator, the manifold adapted to divert driving fluid into the process fluid tank to pressurise the process fluid therein.

13. The apparatus of claim 12, further comprising a flow restrictor intermediate the regulator and the flow adjustor, the restrictor comprising an elongate body having a bore whose diameter is substantially constant and less than that of the driving fluid supply line.

14. The apparatus of claim 10, wherein the frame forms part of a backpack to be carried by an operator.

15. The apparatus of claim 10, wherein the frame forms part of a trailer which can be towed by a vehicle.
